(19) United States
(12) Patent Application Publication
(10) Pub. No.: US 2017/0237839 A1
(43) Pub. Date: Aug. 17, 2017

(54) Battery anti-theft cage apparatus and method for use in a variety of smart devices

(71) Applicant: Abraham Inetianbor, Oakland Park, FL (US)

(72) Inventor: Abraham Inetianbor, Oakland Park, FL (US)

(21) Appl. No.: 15/330,940

(22) Filed: May 8, 2015

(51) Int. Cl. H04M 1/02; G06F 1/16

(52) U.S. Cl. CPC H04M 1/0202; G06F 1/1635; G06F 1/1626; H04M 2001/0204

(57) ABSTRACT

The anti-theft cage apparatus protection and securing apparatus for use in a variety of smart devices enable a user to affix the apparatus to the back of the user's smart phone and secure the smart device's battery within the smart device, allowing the battery to be removed, and tracking function to be disabled, in the event the device is stolen. The apparatus includes at least one securing mechanism that may be locked to the back of the device and is housed within the securing mechanism's housing grooves. Once the apparatus is “locked,” the battery may not be removed until the user disables the locking device and removes the apparatus from around the smart device battery. When the smart device expires, the user may simply remove the apparatus from the smart device and insert into another smart device.

### CROSS-REFERENCE TO RELATED APPLICATION

n/a

### STATEMENT REGARDING FEDERALLY SPONSORED RESEARCH OR DEVELOPMENT

n/a

### FIELD

The present embodiment relates to a battery anti-theft cage apparatus and method of use, and in particular, to a battery anti-theft cage apparatus and method for use in a variety of smart phone devices.

### BACKGROUND

Theft of smart phone and other smart devices continue to increase worldwide despite efforts of major smart phone manufacturers, APP designers, and law enforcement. Further, the thefts of these expensive devices are often associated with other violent crimes. For example, in 2013, there were nearly 8,500 reported instances of smart phone thefts in New York City alone. Of those reported thefts, over 75% were IPhone®, Androids®, and other smart devices.

The 25% increase in reported thefts were attributed to the increased value of these smart phones and smart devices and the ability of modern thieves to disable tracking technology. Despite, law enforcements aggressive educational efforts to increase awareness and safety of these devices, there has been little impact to the reported instances. In fact, law enforcement statistics show that theft of the popular Iphone® and Ipad® continue to rise in spite of these educational awareness campaigns and modern APPs such as the popular “kill switch.”

As a result of the continued increase of smart phone and smart device theft, there is a need for an embodiment that may be affixed to a smart phone or smart devices to prevent tracking features from being disabled. Further, here is a need for an embodiment that deters potential thieves from stealing smart phones and smart devices knowing that their movements will be tracked.

### SUMMARY OF THE INVENTION

In accordance with one aspect, the present invention provides a battery anti-theft cage apparatus and method that has at least one securing mechanism which is releasably affixed, secured to the smart phone and smart phone battery, and a securing cage that may house the smart phone battery which is releasably secured within the securing mechanism. The securing cage is made from a non-flexible pre-fabricated material such as metal, wire, or cable. At least one securing mechanism is affixed to both the smart device and battery and may be further affixed using locking pins or a locking device which allows the user to remove the anti-theft cage apparatus when a user exchanges devices.

Other aspects, advantages, and novel features of the present invention will become apparent from the following detailed description in conjunction with the drawings.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a smart phone to illustrate an environmental perspective;

FIG. 2 is a front perspective view of a smart phone battery without a battery anti-theft cage apparatus for use as an environmental perspective.

FIG. 3 is a front perspective view of a smart phone battery with the battery anti-theft cage apparatus releasably affixed to the smart phone and smart phone battery;

FIG. 4 is a view of the at least one securing mechanism of the battery anti-theft cage apparatus of FIG. 3; and

FIG. 5 is a method for detaching the battery anti-theft cage apparatus of FIG. 3.

### DETAILED DESCRIPTION

Referring now to the drawings wherein the referenced numerals designate identical or corresponding parts throughout the views.

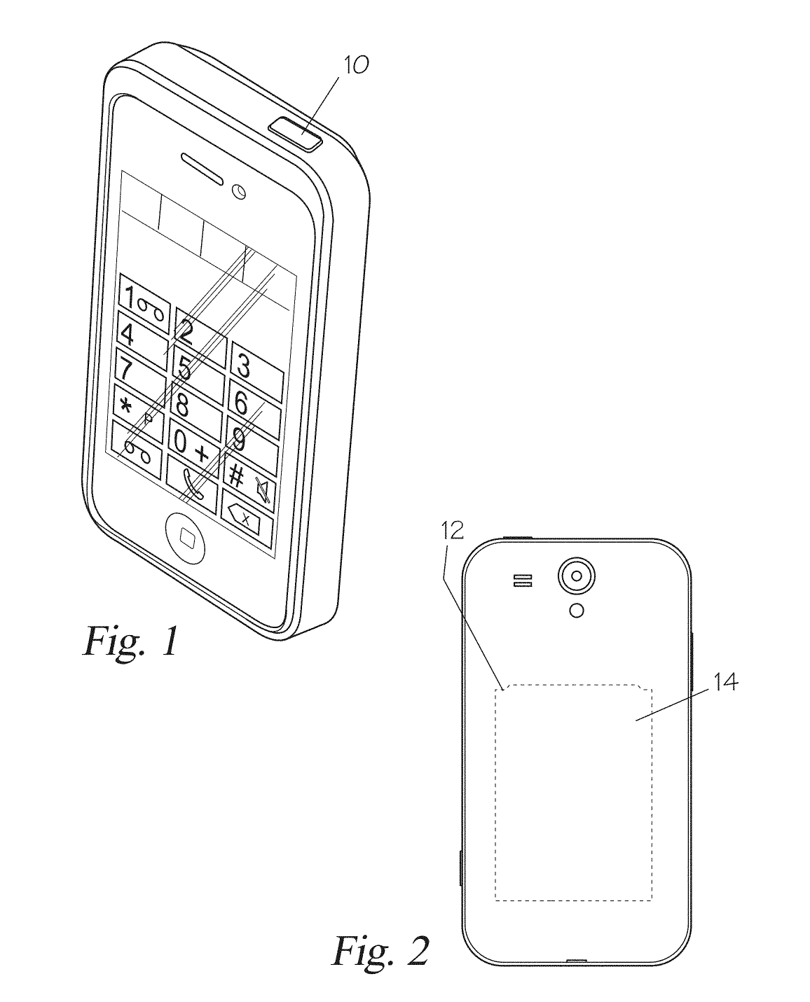

FIG. 1 shows a smart device 10 that may be used to affix apparatus (10) in the first, i.e., open position. A flexible securing strap (12) is affixed to the apparatus (10). The flexible securing strap (12) is designed to wrap around a body part and tensioned for a tight fit in the proximity of the first pad (13) by strap fasteners (14). At least one flexible securing strap (14) is composed of an elastic material such as nylon, and may be further coated with non-slip material, such as silicone, to prevent irritation against the body part. The strap fasteners (14) may be composed of hooks and fasteners, or a Velcro® material that ensures the apparatus (10) is securely positioned and tensioned to the first pad (13). A second pad (15) is affixed to first pad (13), and creates a “flap like” cover to ensure the medical tubes don't get tangled or caught on clothing, as well as cover the exit site. The first pad (13) and second pad (15), including the outside surface of the second pad (16) may be composed of cotton material, polyester-cotton blend material, felt material or a neoprene material.

FIG. 2 shows the apparatus (10) in the first, i.e., open position showing the first pad (17) and the outside of the first pad (18) unfastened and exposing the PICC line hole (20) to the care giver for inspection and disinfecting. When the apparatus (10) is not in use, the second pad cover (15) may be pulled back exposing the inside of the second pad (22). In order to do this, the user of the apparatus (10) must detach the first pad fasteners (23) from the second pad fasteners (24). The first pad fasteners (23) and second pad fasteners (24) may be made of a hook and loop system, or Velcro® material.

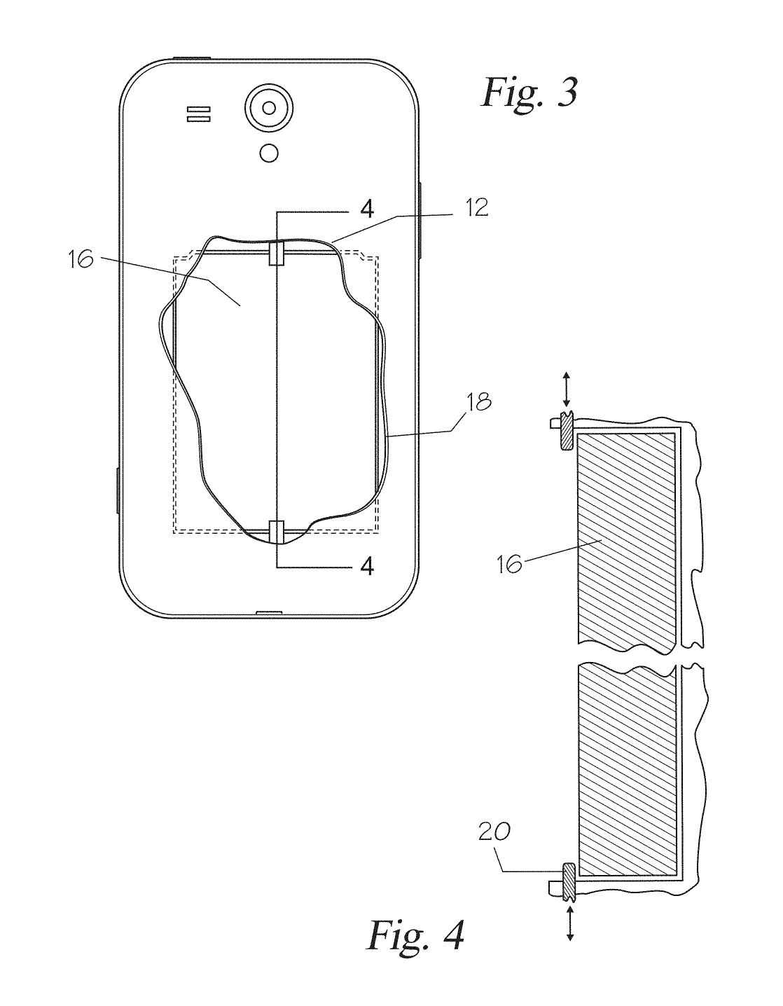

FIG. 3 shows a view of the apparatus (10) attached to a patient's arm in which the apparatus is in the second, i.e., closed position and the second pad cover (15) is unfastened to allow the caregiver access to the PICC line securing straps (26) affixed to the inside cover of the second pad (22), and PICC line (30), threaded through PICC line hole (20).

FIG. 4 shows the apparatus (10) secured around a patient's arm in the second, i.e., closed position in which the second cover pad (15) is transitioning toward the first pad fasteners (28) affixed to the outside of the first pad (18). The PICC line (30) is threaded through the PICC line hole (20) and then further secured to the inside of the second pad (22) using the second PICC line securing straps (26).

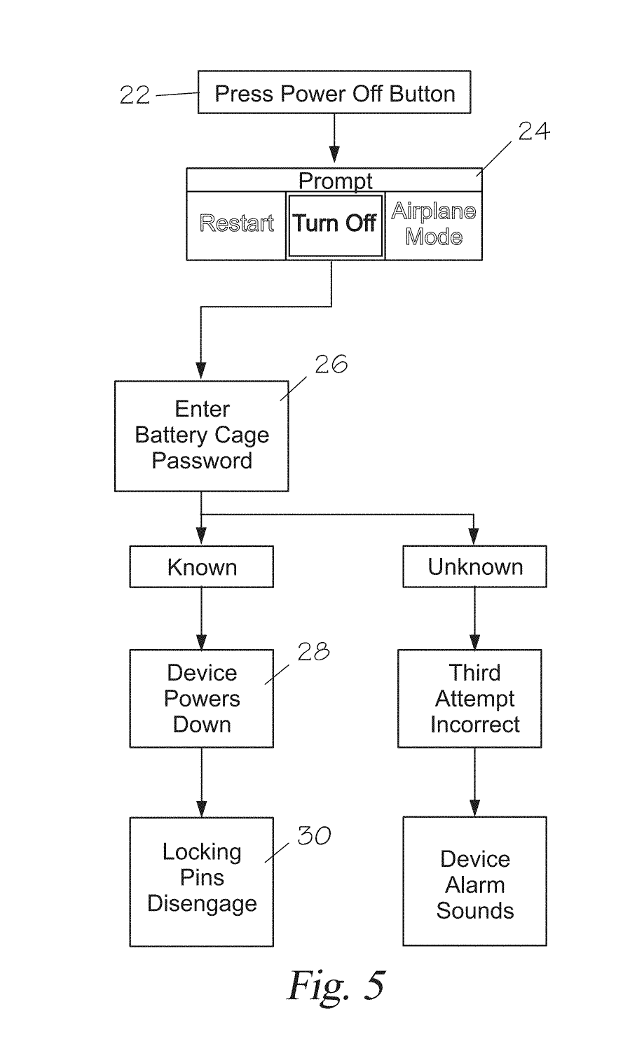

FIG. 5 shows the apparatus (10) secured around the patient's arm in the second, i.e., closed position with the second pad cover (15) attached to the outside of the first pad (18).

Many modifications and variations of the present invention are possible in light of the above teachings. It is therefore understood, that within the premise of the amended claims, the invention may be practiced other than currently described.

What is claimed is:

1. A smartphone battery anti-theft cage apparatus, comprising:
a. at least one first securing mechanism to secure the apparatus to a portion of a smart phone battery and a smartphone, the portion receiving a cage, and
b. a first securing cage, the first securing cage being reliably connected to the at least one securing mechanism so that the securing cage may be secured to the at least one securing mechanism, the securing cage being dimensioned and positioned to allow the smartphone battery to be inserted and secured in the securing cage.

2. The apparatus of claim 1, wherein at least one of the first securing mechanism having a locking mechanism to removably fasten a surface of the at least one securing mechanism to a surface of the smartphone.

3. The apparatus of claim 2, wherein the at least one first securing mechanism is configurable to secure the securing cage to the at least one securing mechanism.

4. The apparatus of claim 1, wherein the securing cage may be comprised of metal or a wiring element.

5. A battery anti-theft cage apparatus configured to prevent the theft of a smart phone, the apparatus comprising of:
a. a cage dimensioned to reliably secure a smartphone battery to at least a securing mechanism to prevent disabling any smartphone functions.

5. The battery anti-theft cage apparatus of claim 5, further comprises the at least one securing mechanism being releasably affixed to a smart phone and a smart phone battery by at least a locking mechanism.

7. The battery anti-theft cage apparatus of claim 6, wherein the at least one locking mechanism is a locking pin.

8. The battery anti-theft cage apparatus of claim 5, wherein the at least one securing mechanism includes a securable groove to receive the cage.
